(19) United States
(12) Patent Application Publication
(10) Pub. No.: US 2009/0217883 A1
(43) Pub. Date: Sep. 3, 2009

(54) Sheep and Goat Handling Apparatus

(76) Inventor: Randolph Ray Moore, Killeen, TX (US)

Correspondence Address: AARON M. WILKERSON, P.O. BOX 588, CHINA SPRING, TX, 76633, US

(21) Appl. No.: 12/040,351

(22) Filed: Feb. 29, 2008

(51) Int. Cl. A01K 1/00

(52) U.S. Cl. 119/514

(57) ABSTRACT

The present invention provides a safe, stress-limiting and efficient apparatus for handling sheep and goats. The apparatus comprises a plurality of partitions, a plurality of horizontally disposed partition connecting members and a plurality of doors attached to said partitions by a plurality of hinge members. The apparatus allows for the efficient and safe handling of large numbers of sheep and goats.

### BACKGROUND OF THE INVENTION

1. Field of the Invention

The present inventive subject matter relates to an apparatus useful for the humane and safe handling of sheep and goats that alleviates stress levels experienced by sheep and goats.

2. Background Information

The health of sheep and goats, and other domesticated animals within the family Bovidae, subfamily Caprinae, is particularly susceptible to stress afflictions resulting from stressful events such as overcrowding, transportation, noise, physical handling by humans, isolation and adverse weather conditions. Stress can adversely affect the immune system of even very healthy sheep and goats. An adversely affected immune system in a sheep or a goat can lead to illness and disease, including respiratory infections, pneumonia, and conditions that allow internal and external parasite infestation. External parasites that afflict sheep and goats include lice, nose bot flies, keds, fly maggots, mites and fleas. Internal parasites that plague sheep and goats include Haemondous contortus, Stongyloides papillosus, Moneizia expansa, and Fasciola hepatica. The overall health of a sheep or a goat is generally inversely proportional to the stress levels experienced by the sheep or goat.

A caretaker's diligent monitoring of the sheep or goat's stress levels generally results in a healthier sheep or goat. Sheep and goats should be fed, watered, examined and treated regularly. Sheep and goats should also be wormed often to eliminate infections of internal and external parasites which can cause increased stress levels resulting in harm and misery to the sheep and goats. Efforts to combat external and internal parasites in sheep and goats include various pesticides and chemical and herbal wormers and different methods of administering said pesticides and wormers to the sheep and goats.

Conventional pesticide and wormer administration methods and devices currently exist that include capture of the sheep or goat physically by human touch or man-handling, complex automatic devices that physically manipulate the sheep or goat (for example, by tipping over or otherwise inverting the sheep or goat) and herding pens. These currently known methods and devices actually induce stress in the sheep and goats, which somewhat defeat the purpose of the wormer, i.e., to provide for the overall health of the sheep or goat. The human touching method by physical capture and man-handling may be unsafe to the sheep or goat and can impart cruelty to the sheep or goat. This method is time-consuming, inefficient, ineffective and can often adversely affect the health of the sheep, the goat and even the caretaker. Complex automatic devices are often expensive, stress-inducing and suffer from inefficiency and ineffectiveness. In addition, herding pens typically are used to crowd the sheep or goats into a confined area, where the sheep or goats are then often physically manipulated and individually isolated into smaller pens.

Information relevant to attempts to address the above-referenced problems can be found in U.S. Pat. No. 4,312,300 to Hopkins (1982), U.S. Pat. No. 3,941,095 to Hamilton et al. (1976), U.S. Pat. No. 4,350,121 to Lemin (1982), U.S. Pat. No. 4,275,685 to Hopkins (1981), U.S. Pat. No. 5,163,383 to Roy (1992), U.S. Pat. No. 4,123,993 to Whiteley (1978) and U.S. Pat. No. 4,850,308 to Padgett (1989). However, each one of these references suffers from one or more of the following disadvantages:
1. the apparatus or method involves physical manipulation or inversion of the animal;
2. the apparatus or method is complex;
3. the apparatus or method is expensive;
4. the apparatus or method is inefficient;
5. the apparatus or method is stress-inducing.

In view of the limitations of products and methods currently known in the art, there is a need for a simple, safe, cruelty-free, efficient, effective and stress-limiting sheep and goat handling apparatus. The present invention, by its novel design provides a solution in view of currently available devices and methods.

### SUMMARY OF THE INVENTION

In view of the foregoing, it is an object of the present invention to provide an apparatus for handling a large number of sheep and goats quickly and efficiently and generally alleviating the arduous nature of the operation as associated with conventional methods.

It is another object of the present invention to provide an apparatus for handling sheep and goats that is extremely efficient.

It is another object of the present invention to provide an apparatus for handling sheep and goats that is extremely safe and cruelty-free.

It is another object of the present invention to provide an apparatus for handling sheep and goats that is extremely effective.

It is yet another object of the present invention to provide an apparatus for handling sheep and goats that is simple and stress-limiting.

In satisfaction of these and other related objectives, the present invention provides such an apparatus for handling sheep and goats. The apparatus, although simplistic is not only novel in concept, but it is also unobvious in view of the current state of the art in sheep and goat handling apparatuses.

The present invention simply incorporates a plurality of partitions, a plurality of doors and a plurality of partition connecting members to provide an effective solution to the current problems in the art in handling sheep and goats. The present invention contemplates the connecting of a plurality of partitions and doors together to accommodate the examination and treatment of any number of sheep and goats. The greater number of partitions and doors that are attached together as set forth herein, the larger number of sheep and goats that can be efficiently provided care.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a simple sheep and goat handling apparatus;

FIG. 2 is a side view of a partition within the sheep and goat handling apparatus;

FIG. 3 is a side view of a door within the sheep and goat handling apparatus;

FIG. 4 is a top plan view of a pair of goats entering the sheep and goat handling apparatus;

FIG. 5 is a top plan view of a pair of goats contained within the sheep and goat handling apparatus;

FIG. 6 is a top plan view of a pair of goats exiting the sheep and goat handling apparatus.

### DESCRIPTION

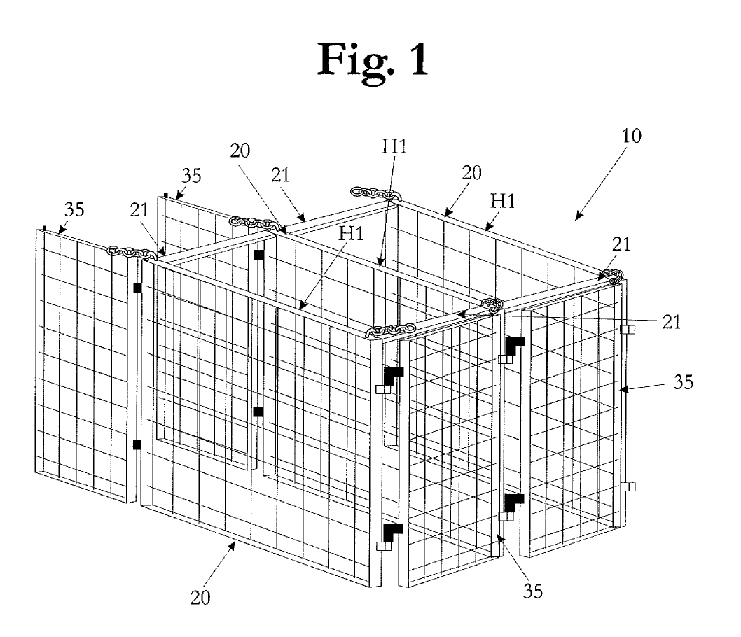

As shown in simple form in FIG. 1, a sheep and goat handling apparatus 10 is comprised of a plurality of partitions 20, a pair of horizontal partition connecting members 21 and a plurality of doors 35.

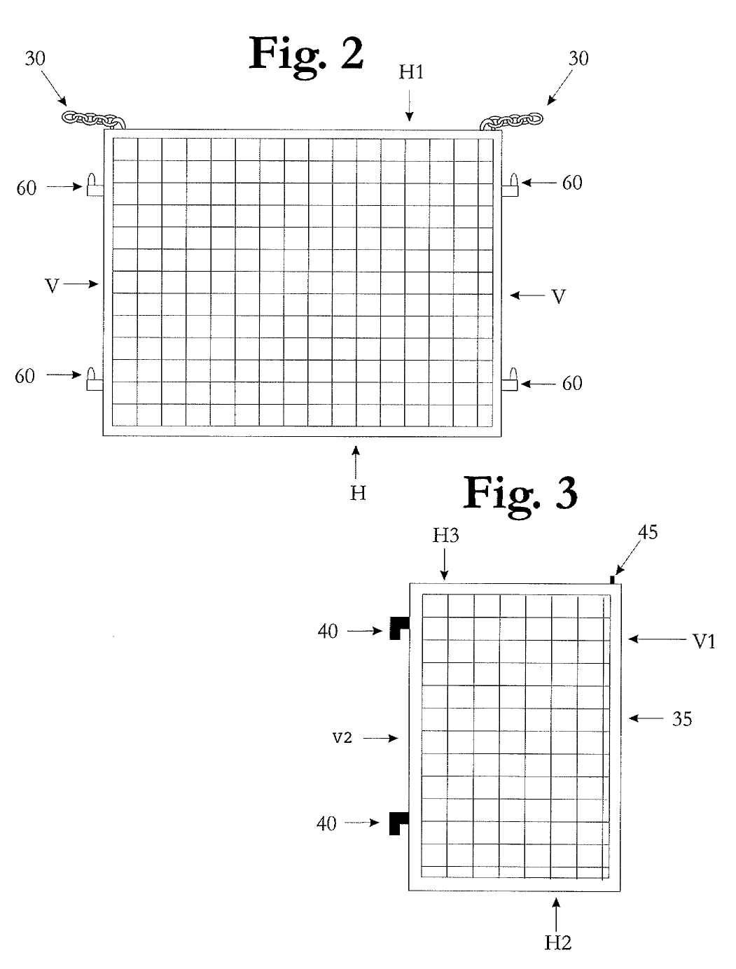

As shown in FIG. 2, a partition 20 is comprised of a plurality of horizontally disposed members H (the uppermost horizontally disposed member is sometimes designated as H1) lying parallel to each other and substantially in a vertical plane. The horizontal members H are secured together to form a substantially rectangular structure by vertically disposed members V secured at the ends of the horizontal members H. A partition 20 is further comprised of a panel 25 that is disposed between and secured to horizontal members H and vertical members V. In the preferred embodiment, the horizontal members H and the vertical members V are constructed of 1½ inch angle iron and welded together by conventional means and the panel 25 is constructed of sturdy iron mesh fencing and welded to the horizontal members H and vertical members V by conventional means; however, other alloys and suitable materials and suitable welding or attachment means are contemplated as well. The addition of the panel 25 provides strength and durability to the partition 20, as well as providing a barrier to prevent escape by an animal contained within the apparatus 10. In addition, a door securing means 30, preferably a chain, is attached by conventional means to each end of horizontally disposed member H1. The partition is further comprised of two pairs of pintles 60. As shown on FIG. 2, two pintles 60 are secured near the top of each vertical member V and the other two pintles 60 are secured near the bottom of each vertical member V.

As further shown on FIG. 1, two partitions 20 are fixedly attached together by a pair of horizontal partition connecting members 21 at each end of the uppermost horizontal disposed member H1. Using the horizontal partition connecting members 21, a plurality of partitions can be affixed together. In the preferred embodiment, the horizontal partition connecting members 21 are constructed of 1½ inch angle iron and are fixedly attached to each end of the uppermost horizontal disposed member H1 by conventional means such as welding; however, other alloys and suitable materials and suitable welding or attachment means are contemplated as well.

As shown in FIG. 3, a door 35 is comprised of a plurality of horizontally disposed members H2 and H3 lying parallel to each other and substantially in a vertical plane. The horizontal members H2 and H3 are secured together to form a substantially rectangular structure by vertically disposed members V1 and V2 secured at the ends of the horizontal members H2 and H3. The door 35 is further comprised of a panel 25 that is disposed between and secured to horizontal members H2 and H3 and vertical members V1 and V2. In the preferred embodiment, the horizontal members H2 and H3 and the vertical members V1 and V2 are constructed of 1½ inch angle iron and welded together by conventional means; however, other alloys and suitable materials and suitable welding or attachment means are contemplated as well. The door 35 is provided with a pair of hinge members 40 each mounted near the top and bottom, respectively, of the vertical member V2 by conventional means, preferably by welding the pair of hinge members 40 to the vertical member V2. A pin 45 is secured at an end of horizontally disposed member H3 near vertical member V1. The hinge members 40 are provided with bores (not shown) for receiving the pintles 60 secured to the vertical members V of the partition 20. The door 35 is mounted upon the partition 20 by aligning the hinge members 40 with the pintles 60 and inserting the pintles 60 through the bores, as best seen in FIG. 1.

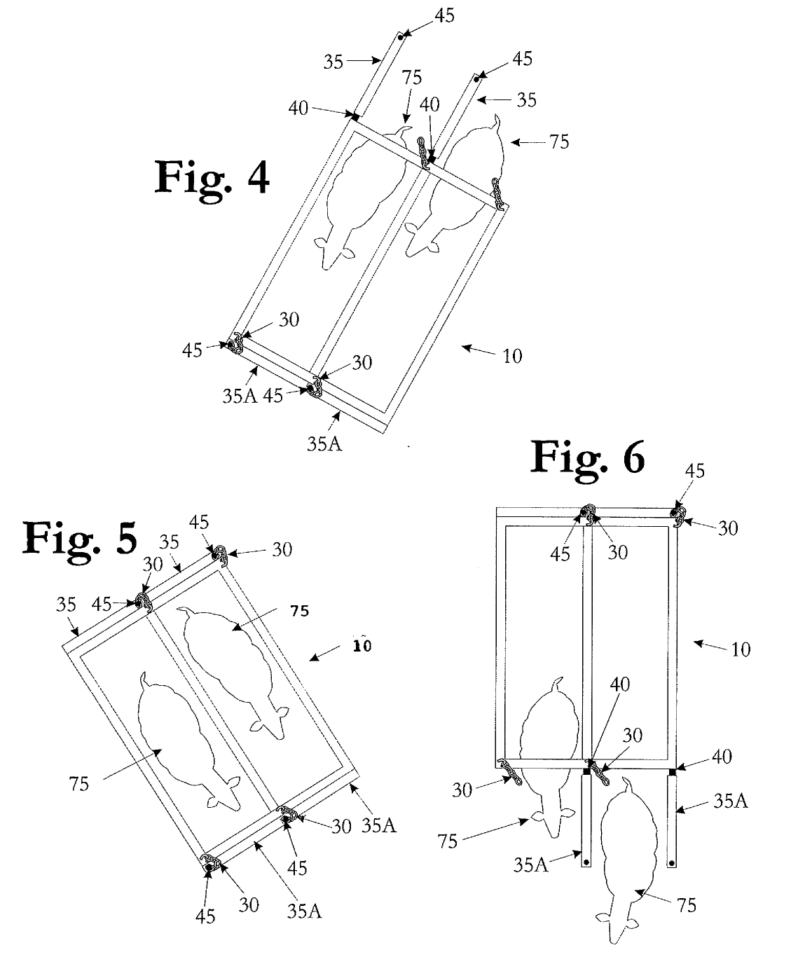

In operation, the sheep and goat handling apparatus 10 is simple but effective, when used as follows, as best seen in FIGS. 4-6. In FIG. 4, a pair of goats 75 is shown entering the sheep and goat handling apparatus 10. The door 35 has been rotated about the hinge members 40 into an open position to allow the goat 75 to enter the sheep and goat handling apparatus 10. A door 35A, mounted to the opposite end of the partition as door 35 is shown in a closed position and affixed to the partition 20 by slidably attaching the door securing means 30 to the pin 45.

FIG. 5 shows a pair of goats 75 contained within the sheep and goat handling apparatus 10. The door 35 has been rotated about the hinge members into a closed position, said door being secured to the partition 20 by slidably attaching the door closing means 30 to the pin 45. When the goats are contained within the sheep and goat handling apparatus 10, the goats can be fed, watered, examined, treated and wormed. The goats are not physically man-handled and will be contained within the sheep and goat handling apparatus 10 with a low level of stress.

FIG. 6 shows the goats exiting the sheep and goat handling apparatus. The door securing means 30 has been released from the pin 45 and has been rotated about the hinge members 40 into the open position. The door 35A can then be rotated into the closed position about its hinge members 40 and secured by the door securing means 30, the door 35 can be rotated into the open position about its hinge members 40, and another goat can be fed, watered, examined, treated and wormed in a low-stress environment.

Therefore, the sheep and goat handling apparatus 10 in a novel, yet unobvious fashion provides a solution to the deficiencies of the prior art in a simple, effective, stress-limiting, cruelty-free package.

Although the description above contains many specifications, these should not be construed as limiting the scope of the present invention. They merely provide illustrations of some of the presently preferred embodiments of the present invention. It will further be understood that various changes in the details, materials and arrangements of the parts and parameters which have been described and illustrated to explain the nature of the invention may be made by those skilled in the art without departing from the principle and scope of the invention. Therefore, the spirit and scope of the appended claims should not be limited to the description of the preferred versions contained herein.

What is claimed is:

1. A sheep and goat handling apparatus comprising:
a plurality of partitions, said partitions being comprised of a plurality of horizontally disposed members and a plurality of vertically disposed members, said horizontally disposed members lying parallel to each other and substantially in a vertical plane and said horizontally disposed members secured together to form a substantially rectangular structure by said vertically disposed members, said partitions being further comprised of a panel that is disposed between and secured to said horizontally disposed members and said vertically disposed members;
a plurality of doors, said doors being comprised of a plurality of horizontally disposed members and a plurality of vertically disposed members, said horizontally disposed members lying parallel to each other and substantially in a vertical plane and said horizontally disposed members secured together to form a substantially rectangular structure by said vertically disposed members, said doors being further comprised of a panel that is disposed between and secured to said horizontally disposed members and said vertically disposed members;
a plurality of horizontally disposed partition connecting members;
a plurality of door securing means;
a plurality of hinge members; and
a plurity of pintles.
